(19) United States
(12) Patent Application Publication
(10) Pub. No.: US 2024/0156193 A1
(43) Pub. Date: May 16, 2024

(54) ADAPTIVE FABRICS FOR ENERGY HARVESTING AND FILTERING

(71) Applicant: Sony Group Corporation, Tokyo (JP)

(72) Inventors: Silvia ROSSELLI, Stuttgart (DE); Elham KHODABAKHSHI SHALAMZARI, Stuttgart (DE); Diana HENNIG, Stuttgart (DE); Anthony ROBERTS, Stuttgart (DE); Dennis CHERCKA, Stuttgart (DE); Vitor Angelo Fonseca DEICHMANN, Stuttgart (DE); Simon STAHL, Stuttgart (DE); Gabriele NELLES, Stuttgart (DE); Simon HENNING, Stuttgart (DE); Tomoaki TAKUMA, Stuttgart (DE); Shigeaki SUZUKI, Stuttgart (DE); Tatsuya YAGIHASHI, Stuttgart (DE); Kentaro SHIBUKAWA, Stuttgart (DE)

(73) Assignee: Sony Group Corporation, Tokyo (JP)

(21) Appl. No.: 18/284,322

(22) PCT Filed: Mar. 16, 2022
(86) PCT No.: PCT/EP2022/056870

§ 371 Date: Sep. 27, 2023

(30) Foreign Application Priority Data
Mar. 31, 2021 (EP) 21166237.4

(51) Int. Cl. A41D 31/04; B32B 5/02; B32B 5/06; H01G 9/20; H02N 1/04

(52) U.S. Cl. CPC A41D 31/04; B32B 5/024; B32B 5/026; B32B 5/06; H01G 9/2031; H02N 1/04; B32B 2250/20; B32B 2255/205; B32B 2262/0261; B32B 2262/103; B32B 2307/4023; B32B 2311/08; B32B 2437/00

(57) ABSTRACT

The field of the DISCLOSURE lies in adaptive materials for implementation in textiles, wearables and smart clothing. The present disclosure relates to functional fabrics or devices, comprising energy-harvesting fabrics or fiber-based materials which change characteristics upon stimulation with at least one stimulus selected from touch, pressure, friction or light. The present disclosure also relates to the use of said functional fabrics or devices, in particular as pressure or friction or touch sensor or in fabrics being in contact with body parts during walking or running. The present disclosure also relates to the use of said functional fabrics or devices as photo-voltaic or light sensors. The present disclosure also relates to electrostatic boost filter devices comprising said functional fabrics or devices, and their uses to filter particulate matter and/or to filter and clean air.

### BACKGROUND

The field of the DISCLOSURE lies in adaptive materials for implementation in textiles, wearables and smart clothing.

The present disclosure relates to functional fabrics or devices, comprising energy-harvesting fabrics or fiber-based materials which change characteristics upon stimulation with at least one stimulus selected from touch, pressure, friction or light.

The present disclosure also relates to the use of said functional fabrics or devices, in particular as pressure or friction or touch sensor or in fabrics being in contact with body parts during exercising. The present disclosure also relates to the use of said functional fabrics or devices as photo-voltaic or light sensors.

The present disclosure also relates to electrostatic boost filter devices comprising said functional fabrics or devices, and their uses to filter particulate matter and/or to filter and clean air.

### DESCRIPTION OF THE RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

The research and applications of fiber materials are directly related to the daily life of the social populace and the development of relevant revolutionary manufacturing industries. However, conventional fibers and fiber products can no longer meet the requirements of automation and intellectualization in modern society, as well as people's consumption needs in their pursuit of smart, avant-garde, fashion and distinctiveness.

### SUMMARY

In the following, the elements of the invention will be described. These elements are listed with specific embodiments, however, it should be understood that they may be combined in any manner and in any number to create additional embodiments. The variously described examples and preferred embodiments should not be construed to limit the present invention to only the explicitly described embodiments. This description should be understood to support and encompass embodiments which combine two or more of the explicitly described embodiments or which combine the one or more of the explicitly described embodiments with any number of the disclosed and/or preferred elements. Furthermore, any permutations and combinations of all described elements in this application should be considered disclosed by the description of the present application unless the context indicates otherwise.

The present disclosure provides a functional fabric or device, comprising energy-harvesting fabrics or fiber-based materials which change characteristics upon stimulation with at least one stimulus selected from touch, pressure, friction or light.

The present disclosure provides using a fabric or device of the present disclosure
as pressure sensor or friction sensor or touch sensor,
to provide power to/charge low power internet-of-things (IoT) devices, low power accelerometers, e.g. fall detector sensor, or LED,
in fabrics being in contact with body parts wherein during exercising, such as walking or running, contacting is possible,
in fabrics, in particular in parts of fabrics where air is passing through,
in fabrics, in particular in parts of fabrics where due to the heart beat and/or pulse contacting is possible,
in fabrics, in particular in parts of fabrics wherein through body movements which are passive or deliberate contacting is possible,
in bicycle and car wheels,
in shoes,
in flooring,
in jewelry,
in accessories worn or carried,
in clothing,
in roads and highways.

The present disclosure provides using a fabric or device of the present disclosure for determining different materials and surfaces.

The present disclosure provides a pressure sensor or friction sensor or touch sensor, comprising a fabric or device according to the present disclosure, and electronics.

The present disclosure provides wearable electronics or smart clothing, comprising a fabric or device according to the present disclosure.

The present disclosure provides using a fabric or device of the present disclosure as a photo-voltaic, a light sensor, a photoresistor or a photodiode.

The present disclosure provides a photo-voltaic, a light sensor, a photoresistor or a photodiode, comprising a fabric or device according to the present disclosure.

The present disclosure provides an electrostatic boost filter device, comprising a fabric or device of the present disclosure.

The present disclosure provides using the electrostatic boost filter device
to filter particulate matter,
as a face filter,
to filter and clean air,
in home ventilation systems,
in window blinds and/or curtains,
in ceiling fans,
in automotive exhaust,
in automotive cabin filters, and/or
in automotive engine air intake filters.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a schematic diagram of a triboelectric nanogenerator (TENG) stack in operation, showing power generation during pressing and releasing.

FIG. 2 shows a schematic diagram of a TENG stack with the two dielectric triboelectric layers separated by an air gap, all sandwiched between two electrodes.

FIG. 3 shows a schematic diagram of a TENG fabric (FIG. 3A) and a fabric TENG (FIG. 3B) as well as voltages and currents generated by tapping and releasing the fabricated TENG fabrics (FIG. 3C).

FIG. 4 shows body parts where friction or impacts are applied.

FIG. 5 shows two schematic fabric self-powered triboelectric air filter (TAF) devices (A and B) of the present disclosure and (C) a table containing the results obtained by particulate matter filtering of air using a fabric self-powered triboelectric air filter (TAF) devices of type A.

FIG. 6 shows uses of an electrostatic boost filter device or triboelectric energy harvesting device of the present disclosure.

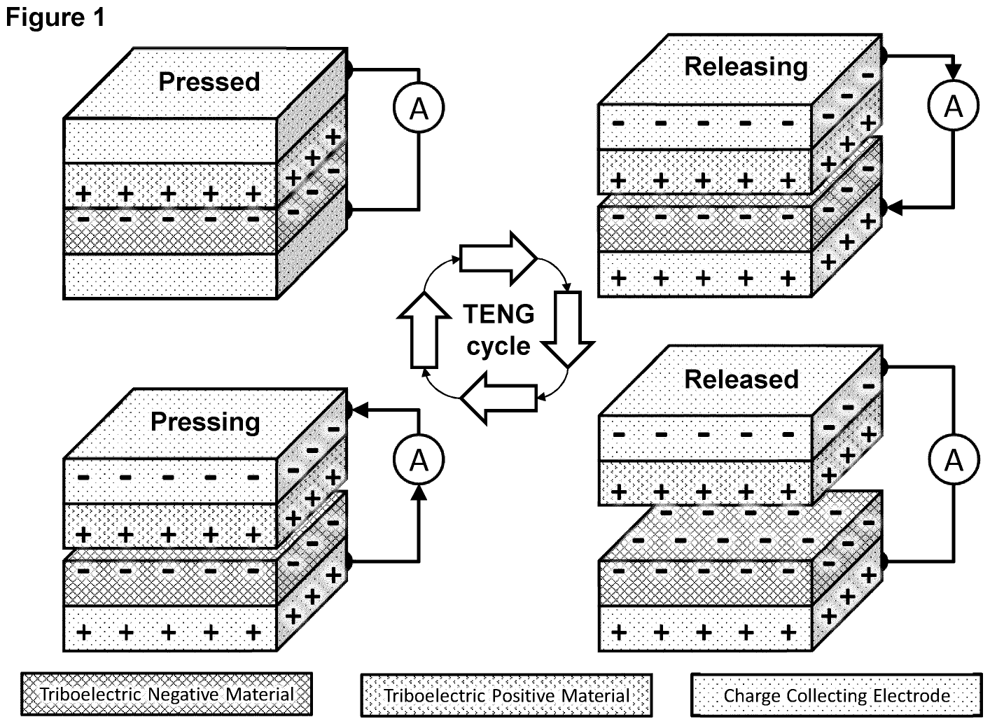

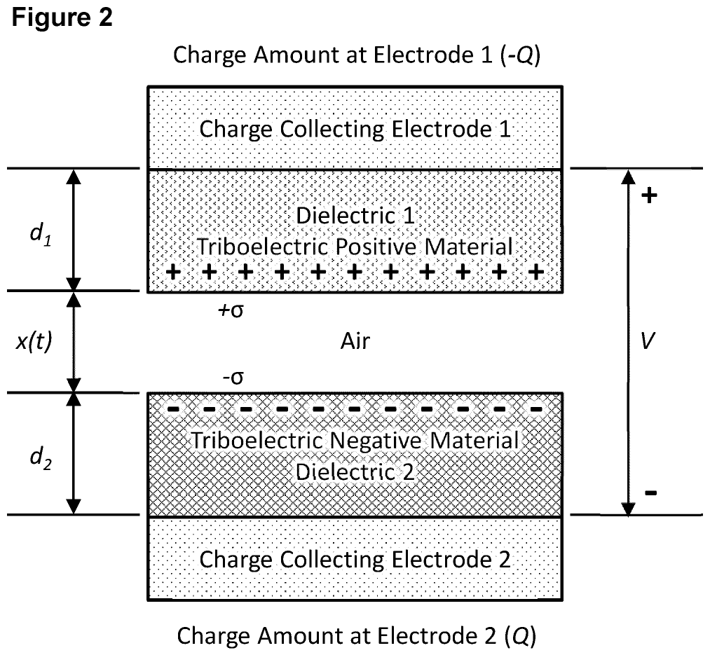

### DETAILED DESCRIPTION OF THE EMBODIMENTS

As discussed above, the present disclosure provides a functional fabric or device. Said functional fabric or device comprises energy-harvesting fabrics or fiber-based materials which change characteristics upon stimulation with at least one stimulus selected from touch, pressure, friction or light.

In a preferred embodiment of said functional fabric or device, said energy-harvesting fabrics or fiber-based material comprises
conductive sheets or fibers or bands laminated with dielectric material(s),
said laminated sheets or fibers or bands being stacked or folded with a gap in between, wherein the energy harvested is mechanical energy.

Said energy is preferably harvested by pressing or applying lateral friction.

In a preferred embodiment of said functional fabric or device, said energy-harvesting fabrics or fiber-based material comprises
fibers or bands of conductive materials and dielectric materials, wherein the core is the conductive material(s) and the shell is the dielectric material(s),
which are woven or knitted, preferably in various patterns,
   wherein the energy harvested is mechanical energy.

Said energy is preferably harvested by pressing or applying lateral friction.

In a preferred embodiment of said functional fabric or device, said energy-harvesting fabrics or fiber-based material comprising coaxial structures which comprise a core conductive and dielectric material(s) applied thereon.

In a preferred embodiment, the stacks of conductive sheets or fibers or bands laminated with dielectric material(s), or the fibers or bands of conductive materials and dielectric materials, or the coaxial structure of a conductive core with dielectric material(s) applied thereon, form an organic nanogenerator.

Said organic nanogenerator is preferably a triboelectric nanogenerator (TENG) structure, more preferably a contact-mode TENG.

In one embodiment, the TENG, preferably the contact-mode TENG, comprises from top to bottom:
(i) a fabric, such as a sheet, fiber or band,
(ii) a first electrode or conductive layer,
(iii) a first dielectric material,
(iv) a spacer layer of air,
(v) a second dielectric material,
(vi) a second electrode or conductive layer,
(v) a fabric, such as a sheet, fiber or band.

Thereby, the first dielectric material and the second dielectric material of the TENG exhibit opposite tribopolarity.

In one embodiment, the TENG, preferably the contact-mode TENG, comprises a coaxial structure which comprises from inside to outside
(I) a core conductive,
(II) a first dielectric material applied onto said conductive core,
(III) a spacer or gap of air,
(IV) a second dielectric material,
(V) a conductive sheath applied onto the dielectric material (IV),
(VI) optionally, an outer sheath of isolating/protective material.

Thereby, the first dielectric material and the second dielectric material of the TENG exhibit opposite tribopolarity.

Preferably, the first dielectric material and the second dielectric material are selected from triboelectric positive materials and triboelectric negative materials, under the proviso that one of the dielectric materials is a triboelectric positive material and the other one is a triboelectric negative material, relative to each other.

Examples of triboelectric positive materials are amber, wood, steel, cotton, paper, polyvinyl acetate (PVAc), polyvinyl alcohol (PVA), polypyridine, poyalkylamine, aluminum, silk, fur, wool, NaCl, polyamide, e.g. Nylon 6, mica, glass, Ta₂O₅, HfO₂, SiO₂, Al₂O₃, TiO₂, Such as SiO₂ (granulate), and polyamide, e.g. Nylon 6.

Examples of triboelectric negative materials are copper (Cu), silver (Ag), gold (Au), polyethylene terephthalate (PET), epoxy resin, natural rubber, polyacrylonitrile (PAN), polyaniline, polybisphenol A carbonate (lexan, PC), polyvinylidene chloride, polyvinylidene fluoride (PVDF), polystyrene (PS), polyethylene (PE), polypropylene (PP), polydimethyl siloxane (PDMS), polyvinyl bromide, polyvinyl chloride (PVC), polyvinyl dichloride, polytetrafluoroethylene (Teflon, PTFE),

Such as PVDF, PTFE, and PDMS.

Examples for first dielectric material and second dielectric material are SiO₂ and PDMS; SiO₂ and PTFE; Nylon 6 and PVDF, Nylon 6 and PDMS; Nylon 6 and PTFE.

In one embodiment, the thickness of the layers of dielectric material (iii) and/or (v) are in a range from about 50 to 500 μm, such as 100 to 200 μm,

In one embodiment, the thickness of the spacer layer of air (iv) is in a range from about 0.2 mm to about 5 mm, such as 0.5 to 3 mm.

As discussed above, the present disclosure provides using a fabric or device of the present disclosure as pressure sensor or friction sensor or touch sensor.

As discussed above, the present disclosure provides using a fabric or device of the present disclosure to provide power to or to charge low power internet-of-things (IoT) devices, low power accelerometers, e.g. fall detector sensor, or LED.

As discussed above, the present disclosure provides using a fabric or device of the present disclosure in fabrics being in contact with body parts wherein during exercising, such as walking or running, contacting is possible.

As discussed above, the present disclosure provides using a fabric or device of the present disclosure in fabrics, in particular in parts of fabrics where air is passing through (e.g. during breathing).

As discussed above, the present disclosure provides using a fabric or device of the present disclosure in fabrics, in particular in parts of fabrics where due to the heart beat and/or pulse contacting is possible.

As discussed above, the present disclosure provides using a fabric or device of the present disclosure in fabrics, in particular in parts of fabrics wherein through body movements which are passive or deliberate (such as arm movement, chest movement, hand movement) contacting is possible.

As discussed above, the present disclosure provides using a fabric or device of the present disclosure in bicycle and car wheels.

As discussed above, the present disclosure provides using a fabric or device of the present disclosure in shoes.

As discussed above, the present disclosure provides using a fabric or device of the present disclosure in flooring.

As discussed above, the present disclosure provides using a fabric or device of the present disclosure in jewelry.

As discussed above, the present disclosure provides using a fabric or device of the present disclosure in accessories worn or carried.

As discussed above, the present disclosure provides using a fabric or device of the present disclosure in clothing.

As discussed above, the present disclosure provides using a fabric or device of the present disclosure in roads and highways.

In one embodiment, the fabric or device comprises fabrics changing its/their capacitance or resistance by pressure or contraction.

As discussed above, the present disclosure provides using such a fabric or device as touch sensor.

In one embodiment, the fabric or device comprises fibers, bands, or fabrics, singly or mixed, which change their voltage, current, inductance, capacitance or resistance via contact with different materials or surfaces.

As discussed above, the present disclosure provides using such a fabric or device for determining different materials and surfaces, such as determination of types of plastic, metal, cardboard, or skin.

As discussed above, the present disclosure provides a pressure sensor or friction sensor or touch sensor, comprising a fabric or device according to the present disclosure, and electronics.

Examples for suitable electronics are pressure transducers, signal convertor, flow sensors, temperature sensor, light intensity sensor, light wavelength sensor, humidity sensor, gas sensor, resistance sensor, and/or strain sensor.

As discussed above, the present disclosure provides wearable electronics or smart clothing, comprising a fabric or device according to the present disclosure.

In a preferred embodiment of said functional fabric or device, said energy-harvesting fabric or fiber-based material comprises sheets or yarn coated or laminated with photoresponsive material(s) or sheets or yarn made of photoresponsive material(s), wherein the energy harvested is light energy and the fabrics change characteristics by absorbing light.

Said yarn is preferably woven or knitted.

In one embodiment, the fabric is coaxial yarn comprised of
(i) a conductive core,
(ii) a photo-voltaic material, which is around the core,
(iii) a transparent conductive material, which is around said photo-voltaic material, forming a sheath.

In one embodiment, the said fabric of coaxial yarn furthermore comprises
(iv) an absorbent material, which is around said sheath, wherein said absorbent material absorbs light at particular wavelength(s).

In one embodiment, the fabric has a stack structure. Said stack structure preferably comprises
(i) a bottom sheet, which is a conductor,
(ii) a photo-voltaic material, which is applied onto the bottom sheet,
(iii) a transparent conductive material, which is applied onto the photo-voltaic material.

In one embodiment, said fabric in stack structure furthermore comprises
(iv) an absorbent material, which is applied onto the transparent conductive material, wherein said absorbent material absorbs light at particular wavelength(s).

In one embodiment, the fabric or device comprises inorganic material(s), such as ZnO, titanium dioxide (TiO₂),
and/or conjugated polymers as conductive material(s), preferably for stack structure, such as [6,6]-phenyl-C₆₁-butyric acid methyl ester (PCBM), poly(3-hexylthiophene) (P3HT),
   dialkoxy substituted poly(p-phenylenevinylenes (PPV), e.g. poly[2-methoxy-5-(3′,7′-dimethyloctyloxy)-1,4-phenylenevinylene] (MDMO-PPV).

In one embodiment, the fabric or device comprises a dye-sensitized solar cell (DSSC) comprising a porous layer of TiO₂ nanoparticles, covered with a molecular dye that absorbs light, immersed in an electrolyte solution, said layers being sandwiched between two electrodes, one of which is a platinum-based catalyst.

As discussed above, the present disclosure provides using said fabric or device as a photo-voltaic.

As discussed above, the present disclosure provides using said fabric or device as a light sensor.

As discussed above, the present disclosure provides using the fabric or device further comprising the absorbent material (iv) as a photoresistor.

As discussed above, the present disclosure provides using the fabric or device further comprising the absorbent material (iv) as a photodiode.

As discussed above, the present disclosure provides a photo-voltaic, comprising a fabric or device according to the present disclosure in said coaxial yarn structure or said stack structure.

As discussed above, the present disclosure provides a light sensor, comprising a fabric or device according to the present disclosure in said coaxial yarn structure.

As discussed above, the present disclosure provides a photoresistor, comprising a fabric or device in said coaxial yarn structure or said stack structure, which comprises the absorbent material (iv).

As discussed above, the present disclosure provides a photodiode comprising a fabric or device in said coaxial yarn structure or said stack structure, which comprises the absorbent material (iv).

As discussed above, the present disclosure provides an electrostatic boost filter device.

Said filter devices comprises a fabric or device of the present disclosure comprising energy-harvesting fabric or fiber-based material, as defined above.

Said energy-harvesting fabric or fiber-based material comprises

non-woven fabrics comprising or being laminated with dielectric material(s) which are stacked.

Preferably, electrostatic absorption efficiency is increased via charging by friction.

In one embodiment, the non-woven fabrics are conductive or comprise conductive material, wherein electrostatic absorption efficiency is preferably increased via applying voltage.

In one embodiment, the stacks of non-woven fabrics comprising or being laminated with dielectric material(s) form an organic nanogenerator.

Said organic nanogenerator is preferably a triboelectric nanogenerator (TENG) structure, more preferably a self-powered triboelectric air filter (TAF).

In one embodiment, the TENG, preferably the TAF, comprises from top to bottom:
(i) a fabric,
(ii) optionally, a first electrode or conductive layer,
(iii) a first dielectric material,
(iv) a spacer layer of air,
(v) a second dielectric material,
(vi) optionally, a second electrode or conductive layer,
(v) a fabric, such as a sheet, fiber or band.

Thereby, the first dielectric material and the second dielectric material exhibit opposite tribopolarity, under the proviso that one of the dielectric materials is a triboelectric positive material and the other one is a triboelectric negative material, relative to each other.

The first dielectric material and the second dielectric material are preferably as defined herein.

For example, a first dielectric material and a second dielectric material are Nylon 6 fabrics and PTFE.

In one embodiment, the TENG, preferably the TAF, comprises from top to bottom
(i) a fabric,
(ii) an electrode or conductive layer,
(iii) a dielectric material.

For example, Nylon 6 fabrics coated with silver nanowires.

As discussed above, the present disclosure provides using the electrostatic boost filter device of the present disclosure to filter particulate matter.

For example, to filter dust, pollen, bacteria, viruses.

As discussed above, the present disclosure provides using the electrostatic boost filter device of the present disclosure as a face filter.

As discussed above, the present disclosure provides using the electrostatic boost filter device of the present disclosure to filter and clean air.

As discussed above, the present disclosure provides using the electrostatic boost filter device of the present disclosure in home ventilation systems.

As discussed above, the present disclosure provides using the electrostatic boost filter device of the present disclosure in window blinds and/or curtains.

As discussed above, the present disclosure provides using the electrostatic boost filter device of the present disclosure in ceiling fans.

As discussed above, the present disclosure provides using the electrostatic boost filter device of the present disclosure in automotive exhaust.

As discussed above, the present disclosure provides using the electrostatic boost filter device of the present disclosure in automotive cabin filters.

As discussed above, the present disclosure provides using the electrostatic boost filter device of the present disclosure in automotive engine air intake filters.

In one embodiment, the filter device senses the amount of particulates filtered into the filter, and/or the airflow through the filter.

Note that the present technology can also be configured as described below.

(1) A functional fabric or device, comprising energy-harvesting fabrics or fiber-based materials which change characteristics upon stimulation with at least one stimulus selected from touch, pressure, friction or light.

(2) The fabric or device of embodiment (1), wherein said energy-harvesting fabrics or fiber-based material comprises
conductive sheets or fibers or bands laminated with dielectric material(s), said laminated sheets or fibers or bands being stacked or folded with a gap in between,
   wherein the energy harvested is mechanical energy, and said energy is preferably harvested by pressing or applying lateral friction.

(3) The fabric or device of embodiment (1), said energy-harvesting fiber-based material, comprising
fibers or bands of conductive materials and dielectric materials, wherein the core is the conductive material(s) and the shell is the dielectric material(s),
which are woven or knitted, preferably in various patterns,
   wherein the energy harvested is mechanical energy, and said energy is preferably harvested by pressing or applying lateral friction.

(4) The fabric or device of embodiment (1), said energy-harvesting fiber-based material comprising coaxial structures which comprise a core conductive and dielectric material(s) applied thereon.

(5) The fabric or device of any one of embodiments (1) to (4), wherein the stacks of conductive sheets or fibers or bands laminated with dielectric material(s), or the fibers or bands of conductive materials and dielectric materials, or the coaxial structure of a conductive core with dielectric material(s) applied thereon, form an organic nanogenerator, preferably a triboelectric nanogenerator (TENG) structure, more preferably a contact-mode TENG.

(6) The fabric or device of embodiment (5), wherein the TENG, preferably the contact-mode TENG, comprises from top to bottom:
(i) a fabric, such as a sheet, fiber or band,
(ii) a first electrode or conductive layer,
(iii) a first dielectric material,
(iv) a spacer layer of air,
(v) a second dielectric material,
(vi) a second electrode or conductive layer,
(v) a fabric, such as a sheet, fiber or band,
   or comprises from inside to outside
(I) a core conductive,
(II) a first dielectric material applied onto said conductive core,
(III) a spacer or gap of air,
(IV) a second dielectric material,
(V) a conductive sheath applied onto the dielectric material (IV),
(VI) optionally, an outer sheath of isolating/protective material.
   wherein the first dielectric material and the second dielectric material exhibit opposite tribopolarity,
   wherein the first dielectric material and the second dielectric material are preferably selected from
triboelectric positive materials,
   such as amber, wood, steel, cotton, paper, polyvinyl acetate (PVAc), polyvinyl alcohol (PVA), polypyridine, poyalkylamine, aluminum, silk, fur, wool, NaCl, polyamide (e.g. Nylon 6), mica, glass, Ta₂O₅, HID2, SiO₂, Al₂O₃, TiO₂,
triboelectric negative materials,
   such as copper (Cu), silver (Ag), gold (Au), polyethylene terephthalate (PET), epoxy resin, natural rubber, polyacrylonitrile (PAN), polyaniline, polybisphenol A carbonate (lexan, PC), polyvinylidene chloride, polyvinylidene fluoride (PVDF), polystyrene (PS), polyethylene (PE), polypropylene (PP), polydimethyl siloxane (PDMS), polyvinyl bromide, polyvinyl chloride (PVC), polyvinyl dichloride, polytetrafluoroethylene (Teflon, PTFE), under the proviso that one of the dielectric materials is a triboelectric positive material and the other one is a triboelectric negative material relative to each other.

(7) The fabric or device of any one of embodiments (2) to (6), wherein the thickness of the layers of dielectric material (iii) and/or (v) are in a range from about 50 to 500 μm, such as 100 to 200 μm,
and/or wherein the thickness of the spacer layer of air (iv) is in a range from about 0.2 mm to about 5 mm, such as 0.5 to 3 mm.

(8) Use of a fabric or device of any one of embodiments (2) to (7),
as pressure sensor or friction sensor or touch sensor,
to provide power to/charge low power internet-of-things (IoT) devices, low power accelerometers, e.g. fall detector sensor, or LED,
in fabrics being in contact with body parts wherein during exercising, such as walking or running, contacting is possible,
in fabrics, in particular in parts of fabrics where air is passing through (e.g. during breathing),
in fabrics, in particular in parts of fabrics where due to the heartbeat and/or pulse contacting is possible,
in fabrics, in particular in parts of fabrics wherein through body movements which are passive or deliberate (such as arm movement, chest movement, hand movement) contacting is possible,
in bicycle and car wheels,
in shoes,
in flooring,
in jewelry,
in accessories, worn or carried,
in clothing, and/or
in roads and highways.

(9) The fabric or device of any one of embodiments (2) to (7), comprising fabrics changing its/their capacitance or resistance by pressure or contraction.

(10) Use of the fabric or device of embodiment (9) as touch sensor.

(11) The fabric or device of any one of embodiments (2) to (7), comprising fibers, bands, or fabrics, singly or mixed, which change their voltage, current, inductance, capacitance or resistance via contact with different materials or surfaces.

(12) Use of the fabric or device of embodiment (11) for determining different materials and surfaces, such as determination of types of plastic, metal, cardboard, or skin.

(13) A pressure sensor or friction sensor or touch sensor, comprising
a fabric or device according to any one of embodiments (1) to (5) or (8), and
electronics, such as pressure transducers, signal convertor, flow sensors, temperature sensor, light intensity sensor, light wavelength sensor, humidity sensor, gas sensor, resistance sensor, strain sensor.

(14). Wearable electronics or smart clothing, comprising a fabric or device according to any one of embodiments (1) to (7) or (11).

(15) The fabric or device of embodiment (1), wherein said energy-harvesting fabric or fiber-based material comprises
sheets or yarn coated or laminated with photoresponsive material(s) or
sheets or yarn made of photoresponsive material(s), said yarn preferably being woven or knitted,
   wherein the energy harvested is light energy and the fabrics change characteristics by absorbing light.

(16) The fabric or device of embodiment (15), wherein the fabric is coaxial yarn comprised of
(v) a conductive core,
(vi) a photo-voltaic material, which is around the core,
(vii) a transparent conductive material, which is around said photo-voltaic material, forming a sheath,
(viii) optional, an absorbent material, which is around said sheath, wherein said absorbent material absorbs light at particular wavelength(s).

(17) The fabric or device of embodiment (15), wherein the fabric has a stack structure, preferably comprising
(i) a bottom sheet, which is a conductor,
(ii) a photo-voltaic material, which is applied onto the bottom sheet,
(iii) a transparent conductive material, which is applied onto the photo-voltaic material,
(ix) optional, an absorbent material, which is applied onto the transparent conductive material, wherein said absorbent material absorbs light at particular wavelength(s).

(18) The fabric or device of any one of embodiments (15) to (17), comprising inorganic material(s), such as ZnO, titanium dioxide (TiO₂),
and/or conjugated polymers as conductive material(s), preferably for stack structure,
   such as [6,6]-phenyl-C₆₁-butyric acid methyl ester (PCBM),
   poly(3-hexylthiophene) (P3HT),
   dialkoxy substituted poly(p-phenylenevinylenes (PPV), e.g. poly[2-methoxy-5-(3′,7′-dimethyloctyloxy)-1,4-phenylenevinylene] (MDMO-PPV).

(19) The fabric or device of any one of embodiments (15) to (18), comprising a dye-sensitized solar cell (DSSC) comprising a porous layer of TiO₂ nanoparticles, covered with a molecular dye that absorbs light, immersed in an electrolyte solution, said layers being sandwiched between two electrodes, one of which is a platinum-based catalyst.

(20) Use of the fabric or device of embodiment (16) or (17) as a photo-voltaic; or use of the fabric or device of embodiment (15) as a light sensor.

(21) Use of the fabric or device of embodiment (16) or (17) as a photoresistor or as a photodiode, wherein said fabric or device comprises the absorbent material (iv).

(22) A photo-voltaic or a light sensor, comprising a fabric or device according to embodiment (16); or a photo-voltaic; comprising a fabric or device according to embodiment (17).

(23) A photoresistor, comprising a fabric or device according to embodiment (16) or (17); or a photodiode comprising a fabric or device according to embodiment (16) or (17), wherein said fabric or device comprises the absorbent material (iv).

(24) An electrostatic boost filter device, comprising a fabric or device of any one of embodiments (1) to (5), wherein said energy-harvesting fabric or fiber-based material comprises
non-woven fabrics comprising or being laminated with dielectric material(s) which are stacked,
   wherein electrostatic absorption efficiency is preferably increased via charging by friction.

(25) The filter device of embodiment (24), wherein the non-woven fabrics are conductive or comprise conductive material,
wherein electrostatic absorption efficiency is preferably increased via applying voltage.

(26) The filter device of embodiment (24) or (25), wherein the stacks of non-woven fabrics comprising or being laminated with dielectric material(s) form an organic nanogenerator, preferably a triboelectric nanogenerator (TENG) structure, more preferably a self-powered triboelectric air filter (TAF).

(27) The filter device of embodiment (26), wherein the TENG, preferably the TAF, comprises from top to bottom:
(i) a fabric,
(ii) optionally, a first electrode or conductive layer,
(iii) a first dielectric material,
(iv) a spacer layer of air,
(v) a second dielectric material,
(vi) optionally, a second electrode or conductive layer,
(v) a fabric, such as a sheet, fiber or band,
   wherein the first dielectric material and the second dielectric material exhibit opposite tribopolarity,
   wherein the first dielectric material and the second dielectric material are as defined in embodiment (5),
   under the proviso that one of the dielectric materials is a triboelectric positive material and the other one is a triboelectric negative material, relative to each other, such as Nylon 6 fabrics and PTFE;
   or the TENG, preferably the TAF, comprises from top to bottom
(i) a fabric,
(ii) an electrode or conductive layer,
(iii) a dielectric material,
   such as Nylon 6 fabrics coated with silver nanowires.

(28) Use of a filter device of any one of embodiments (24) to (27),
to filter particulate matter,
   e.g. dust, pollen, bacteria, viruses,
as a face filter,
to filter and clean air,
in home ventilation systems,
in window blinds and/or curtains,
in ceiling fans,
in automotive exhaust,
in automotive cabin filters, and/or
in automotive engine air intake filters.

(29) The use of embodiment (28), wherein the filter device senses the amount of particulates filtered into the filter, and/or the airflow through the filter.

The advanced fiber-shaped and fiber-form electronics with most desired designability and integration features have been explored and developed by the present inventors. Advanced fiber-based products, such as wearable electronics and smart clothing, can be employed as a second skin to enhance information exchange between humans and the external environment. Active and reactive (adaptive) materials with respect to the environmental and/or the personal situations will increase customer value, opening new possibilities for personalization, emotion expression and product utilization.

The major object of this disclosure is to provide flexible fiber-shaped multifunctional devices, including fiber-based materials having different functionalities and being adaptive/stimuli responsive, meaning changing one or more material properties depending from the stimuli.

### EXAMPLES

### Example 1: Triboelectric Mechanical Energy Harvesting

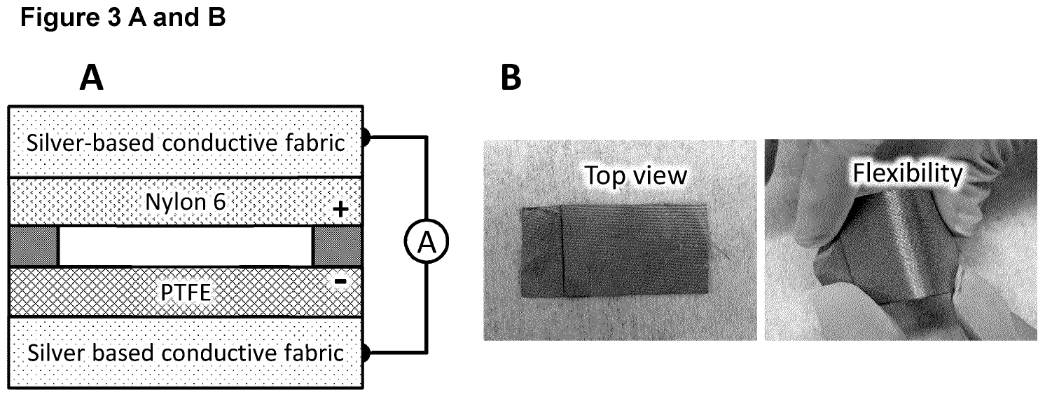

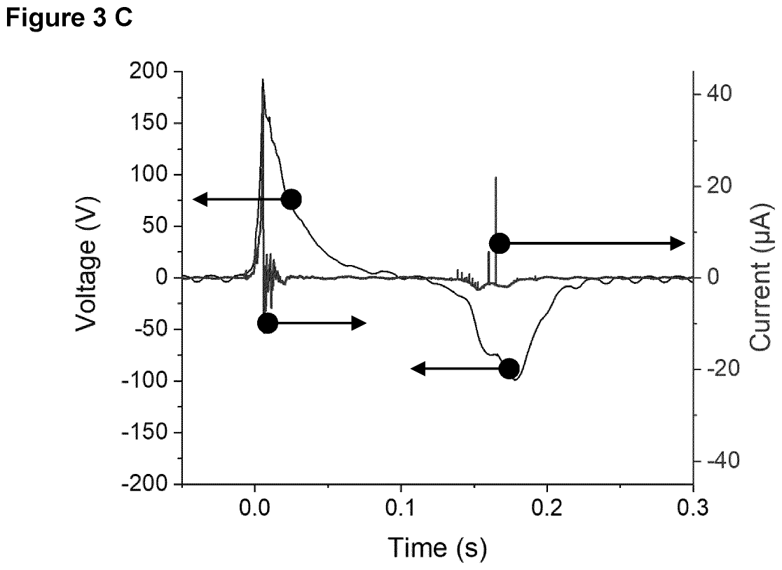

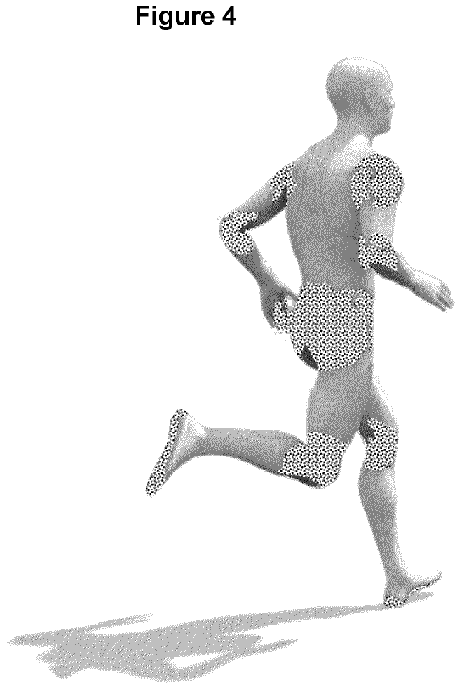

For proof of principle, we prepared the stacks above with size of 3×3 cm and used a regular tapping source. The stack includes ITO/PET as bottom substrate, PTFE with the thickness of 170 μm as negative dielectric layer, spacer with 1 mm thickness and as second layer we used Nylon 6 with the same thickness and again ITO/PET as top electrode. For the measurement setup we used a Keysight CX3324A Current Waveform Analyser to record the voltage, and current. FIG. 3C shows the recorded traces obtained by pressing and releasing by hand a 3×3 cm hammer onto a 7×7 cm anvil with the 10×10 cm TENG device in between the hammer and the anvil. The peak voltage was ˜+180V during strike, and ˜−100V on release. The currents were ˜+10 μA during strike and ˜−5 μA during release, the expected peak power is ˜1.8 mW for ˜10 ms during strike; there were some transient, short-duration, spike currents of ˜40 μA and these will further increase the harvested power.

### Example 2: Electrostatic Filtration

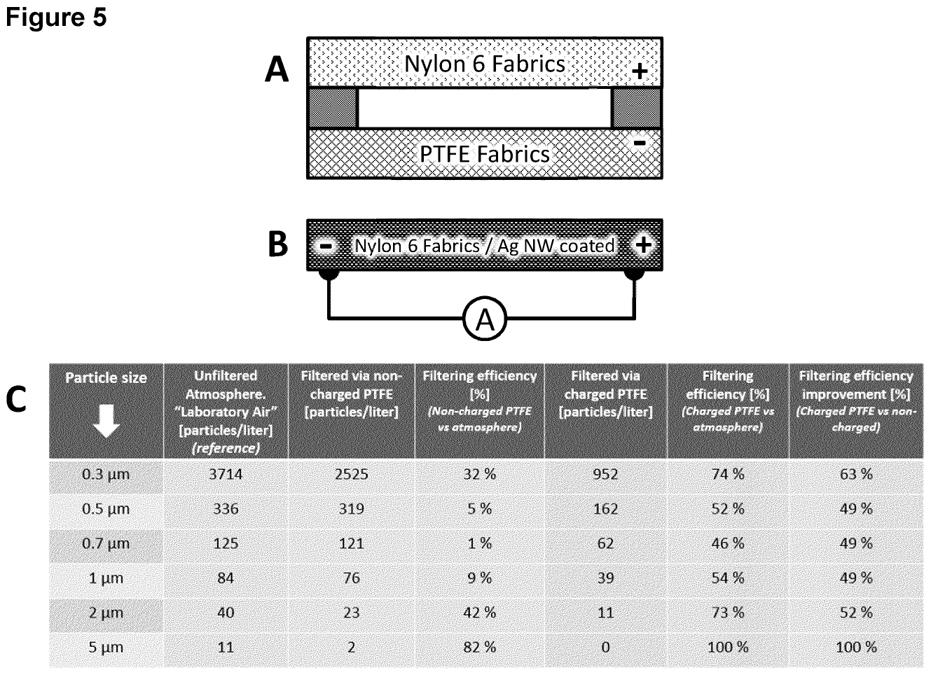

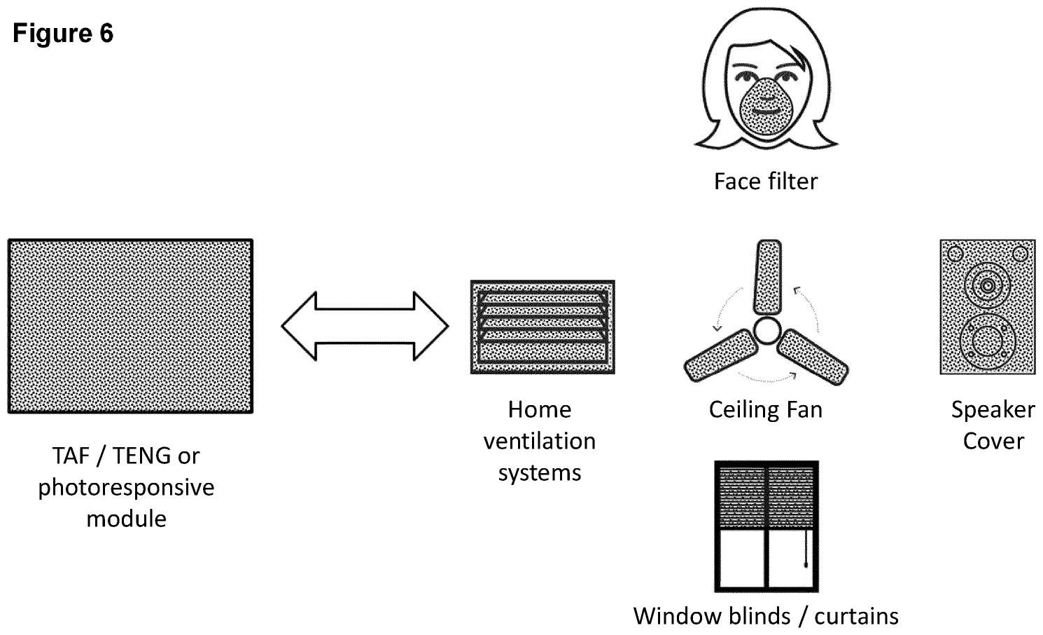

We used PTFE fabric as triboelectric (dielectric material). A Met One particle meter was used to test particle concentration with and without filter (1 minute measurement ˜2.8 Liter air). To check the surface charges a Keyence SK-H050 electrostatic sensor was used. To perform the experiments, the particle meter was used to measure the amount of particles in the lab environment as a reference. Then, a non-charged PTFE fabric was checked with the particle meter. Afterwards, the PTFE fabric was rubbed against a nylon surface and the charging of the PTFE's surface was confirmed by electrostatic sensor. The filtering of the charged PTFE fabric was then tested with the particle meter. Several measurements were done for reliability and reproducibility assessment, and all the measurements showed the same trend—namely an improving filtering efficiency by using charged fabrics due to enhanced electrostatic absorption of particulate matters. The table of results is shown in FIG. 5C.

The features of the present disclosure disclosed in the specification, the claims, and/or in the accompanying figures may, both separately and in any combination thereof, be material for realizing the disclosure in various forms thereof. Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, define, in part, the scope of the foregoing claim terminology such that no inventive subject matter is dedicated to the public.

1. A functional fabric or device, comprising energy-harvesting fabrics or fiber-based materials which change characteristics upon stimulation with at least one stimulus selected from touch, pressure, friction or light.

2. The fabric or device of claim 1, wherein said energy-harvesting fabrics or fiber-based material comprises
conductive sheets or fibers or bands laminated with dielectric material(s),
said laminated sheets or fibers or bands being stacked or folded with a gap in between, wherein the energy harvested is mechanical energy, and said energy is preferably harvested by pressing or applying lateral friction.

3. The fabric or device of claim 1, said energy-harvesting fiber-based material, comprising
fibers or bands of conductive materials and dielectric materials, wherein the core is the conductive material(s) and the shell is the dielectric material(s), which are woven or knitted, preferably in various patterns,
wherein the energy harvested is mechanical energy, and said energy is preferably harvested by pressing or applying lateral friction.

4. The fabric or device of claim 1, said energy-harvesting fiber-based material comprising coaxial structures which comprise a core conductive and dielectric material(s) applied thereon.

5. The fabric or device of claim 1, wherein the stacks of conductive sheets or fibers or bands laminated with dielectric material(s), or the fibers or bands of conductive materials and dielectric materials, or the coaxial structure of a conductive core with dielectric material(s) applied thereon, form an organic nanogenerator, preferably a triboelectric nanogenerator (TENG) structure, more preferably a contact-mode TENG.

6. The fabric or device of claim 5, wherein the TENG, preferably the contact-mode TENG, comprises from top to bottom:
(i) a fabric, such as a sheet, fiber or band,
(ii) a first electrode or conductive layer,
(iii) a first dielectric material,
(iv) a spacer layer of air,
(v) a second dielectric material,
(vi) a second electrode or conductive layer,
(v) a fabric, such as a sheet, fiber or band,
or comprises from inside to outside
(I) a core conductive,
(II) a first dielectric material applied onto said conductive core,
(III) a spacer or gap of air,
(IV) a second dielectric material,
(V) a conductive sheath applied onto the dielectric material (IV),
(VI) optionally, an outer sheath of isolating/protective material.
wherein the first dielectric material and the second dielectric material exhibit opposite tribopolarity,
wherein the first dielectric material and the second dielectric material are preferably selected from
triboelectric positive materials,
such as amber, wood, steel, cotton, paper, polyvinyl acetate (PVAc), polyvinyl alcohol (PVA), polypyridine, poyalkylamine, aluminum, silk, fur, wool, NaCl, polyamide (e.g. Nylon 6), mica, glass, Ta₂O₅, HfO₂, SiO₂, Al₂O₃, TiO₂,
triboelectric negative materials,
such as copper (Cu), silver (Ag), gold (Au), polyethylene terephthalate (PET), epoxy resin, natural rubber, polyacrylonitrile (PAN), polyaniline, polybisphenol A carbonate (lexan, PC), polyvinylidene chloride, polyvinylidene fluoride (PVDF), polystyrene (PS), polyethylene (PE), polypropylene (PP), polydimethyl siloxane (PDMS), polyvinyl bromide, polyvinyl chloride (PVC), polyvinyl dichloride, polytetrafluoroethylene (Teflon, PTFE),
under the proviso that one of the dielectric materials is a triboelectric positive material and the other one is a triboelectric negative material relative to each other.

7. The fabric or device of claim 2,
wherein the thickness of the layers of dielectric material (iii) and/or (v) are in a range from about 50 to 500 μm, such as 100 to 200 μm,
and/or wherein the thickness of the spacer layer of air (iv) is in a range from about 0.2 mm to about 5 mm, such as 0.5 to 3 mm.

8. Use of a fabric or device of claim 2,
as pressure sensor or friction sensor or touch sensor,
to provide power to/charge low power internet-of-things (IoT) devices, low power accelerometers, e.g. fall detector sensor, or LED,
in fabrics being in contact with body parts wherein during exercising, such as walking or running, contacting is possible,
in fabrics, in particular in parts of fabrics where air is passing through (e.g. during breathing),
in fabrics, in particular in parts of fabrics where due to the heartbeat and/or pulse contacting is possible,
in fabrics, in particular in parts of fabrics wherein through body movements which are passive or deliberate (such as arm movement, chest movement, hand movement) contacting is possible,
in bicycle and car wheels,
in shoes,
in flooring,
in jewelry,
in accessories, worn or carried,
in clothing, and/or
in roads and highways.

9. The fabric or device of claim 2, comprising fabrics changing its/their capacitance or resistance by pressure or contraction.

10. Use of the fabric or device of claim 9 as touch sensor.

11. The fabric or device of claim 2, comprising fibers, bands, or fabrics, singly or mixed, which change their voltage, current, inductance, capacitance or resistance via contact with different materials or surfaces.

12. Use of the fabric or device of claim 11 for determining different materials and surfaces, such as determination of types of plastic, metal, cardboard, or skin.

13. A pressure sensor or friction sensor or touch sensor, comprising
a fabric or device according to claim 1, and
electronics, such as pressure transducers, signal convertor, flow sensors, temperature sensor, light intensity sensor, light wavelength sensor, humidity sensor, gas sensor, resistance sensor, strain sensor.

14. Wearable electronics or smart clothing, comprising a fabric or device according to claim 1.

15. The fabric or device of claim 1, wherein said energy-harvesting fabric or fiber-based material comprises
sheets or yarn coated or laminated with photoresponsive material(s) or
sheets or yarn made of photoresponsive material(s),
said yarn preferably being woven or knitted,
wherein the energy harvested is light energy and the fabrics change characteristics by absorbing light.

16. The fabric or device of claim 15, wherein the fabric is coaxial yarn comprised of
(i) a conductive core,
(ii) a photo-voltaic material, which is around the core,
(iii) a transparent conductive material, which is around said photo-voltaic material, forming a sheath,
(iv) optional, an absorbent material, which is around said sheath, wherein said absorbent material absorbs light at particular wavelength(s).

17. The fabric or device of claim 15, wherein the fabric has a stack structure, preferably comprising
(i) a bottom sheet, which is a conductor,
(ii) a photo-voltaic material, which is applied onto the bottom sheet,
(iii) a transparent conductive material, which is applied onto the photo-voltaic material,
(v) optional, an absorbent material, which is applied onto the transparent conductive material, wherein said absorbent material absorbs light at particular wavelength(s).

18. The fabric or device of claim 15, comprising
inorganic material(s), such as ZnO, titanium dioxide (TiO₂),
and/or conjugated polymers as conductive material(s), preferably for stack structure,
such as [6,6]-phenyl-C61-butyric acid methyl ester (PCBM),
poly(3-hexylthiophene) (P3HT),
dialkoxy substituted poly(p-phenylenevinylenes (PPV), e.g. poly [2-methoxy-5-(3′,7′-dimethyloctyloxy)-1,4-phenylenevinylene] (MDMO-PPV).

19. The fabric or device of claim 15, comprising a dye-sensitized solar cell (DSSC) comprising a porous layer of TiO₂ nanoparticles, covered with a molecular dye that absorbs light, immersed in an electrolyte solution, said layers being sandwiched between two electrodes, one of which is a platinum-based catalyst.

20. Use of the fabric or device of claim 16 as a photo-voltaic; or use of the fabric or device of claim 15 as a light sensor.

21. Use of the fabric or device of claim 16 as a photoresistor or as a photodiode, wherein said fabric or device comprises the absorbent material (iv).

22. A photo-voltaic or a light sensor, comprising a fabric or device according to claim 16; or a photo-voltaic; comprising a fabric or device according to claim 17.

23. A photoresistor, comprising a fabric or device according to claim 16, wherein said fabric or device comprises the absorbent material (iv).

24. An electrostatic boost filter device, comprising a fabric or device of claim 1, wherein said energy-harvesting fabric or fiber-based material comprises
non-woven fabrics comprising or being laminated with dielectric material(s) which are stacked,
wherein electrostatic absorption efficiency is preferably increased via charging by friction.

25. The filter device of claim 24, wherein the non-woven fabrics are conductive or comprise conductive material,
wherein electrostatic absorption efficiency is preferably increased via applying voltage.

26. The filter device of claim 24, wherein the stacks of non-woven fabrics comprising or being laminated with dielectric material(s) form an organic nanogenerator, preferably a triboelectric nanogenerator (TENG) structure, more preferably a self-powered triboelectric air filter (TAF).

27. The filter device of claim 26, wherein the TENG, preferably the TAF, comprises from top to bottom:
(i) a fabric,
(ii) optionally, a first electrode or conductive layer,
(iii) a first dielectric material,
(iv) a spacer layer of air,
(v) a second dielectric material,
(vi) optionally, a second electrode or conductive layer,
(v) a fabric, such as a sheet, fiber or band,
wherein the first dielectric material and the second dielectric material exhibit opposite tribopolarity,
under the proviso that one of the dielectric materials is a triboelectric positive material and the other one is a triboelectric negative material, relative to each other, such as Nylon 6 fabrics and PTFE;
or the TENG, preferably the TAF, comprises from top to bottom
(i) a fabric,
(ii) an electrode or conductive layer,
(iii) a dielectric material,
such as Nylon 6 fabrics coated with silver nanowires.

28. Use of a filter device of claim 24,
to filter particulate matter,
e.g. dust, pollen, bacteria, viruses,
as a face filter,
to filter and clean air,
in home ventilation systems,
in window blinds and/or curtains,
in ceiling fans,
in automotive exhaust,
in automotive cabin filters, and/or
in automotive engine air intake filters.

29. The use of claim 28, wherein the filter device senses the amount of particulates filtered into the filter, and/or the airflow through the filter.
